(19) United States
(12) Patent Application Publication
(10) Pub. No.: US 2024/0098752 A1
(43) Pub. Date: Mar. 21, 2024

(54) METHOD, DEVICE, AND SYSTEM FOR POWER SAVING IN WIRELESS NETWORKS

(71) Applicant: ZTE Corporation, Shenzhen (CN)

(72) Inventors: Mengzhu CHEN, Shenzhen (CN); Xuan MA, Shenzhen (CN); Xiaoying MA, Shenzhen (CN); Jun XU, Shenzhen (CN)

(73) Assignee: ZTE Corporation, Shenzhen (CN)

(21) Appl. No.: 18/521,334

(22) Filed: Nov. 28, 2023

Related U.S. Application Data
(63) Continuation of application No. PCT/CN2021/116623, filed on Sep. 6, 2021.

(51) Int. Cl. H04W 72/231; H04B 7/06; H04L 5/00; H04W 68/02; H04W 72/12; H04W 76/20

(52) U.S. Cl. CPC H04W 72/231; H04B 7/0626; H04L 5/0051; H04W 68/02; H04W 72/12; H04W 76/20

(57) ABSTRACT

This disclosure relates generally to a method, device, and system for saving network and User Equipment (UE) power consumption in wireless communications. One method performed by a wireless communication node including transmitting, to a UE, an indication message indicating configuration information for a configuration of at least one element associated with the wireless communication node or the UE, where a type of the configuration comprises one of: an activation of the at least one element, a deactivation of the at least one element, or a configuration update related to the at least one element; and where the at least one element comprises at least one of: a cell, a frequency layer, a frequency band, a carrier, a Transmission and Reception Point (TRP), a beam, a Transmission Configuration Indication (TCI) state, an antenna, an antenna port, a MIMO layer, a rank, an antenna panel, a reference signal, or a reference resource.

### TECHNICAL FIELD

This disclosure is directed generally to wireless communications, and particularly to a method, device, and system for saving network and User Equipment (UE) power consumption.

### BACKGROUND

Controlling power consumption and reducing energy cost is critical for developing and deploying a wireless communication network. Energy saving technology is critical for achieving this goal. With the development of wireless communication technology, more and more elements and functionality are added which increases the complexity for power control. It is critical to have the capability to dynamically control the power consumption in different level of granularities yet still meet performance requirement.

### SUMMARY

This disclosure is directed to a method, device, and system for saving network and User Equipment (UE) power consumption in wireless communications.

In some embodiments, a method performed by a wireless communication node in a wireless network is disclosed. The method may include transmitting, to a User Equipment (UE) in the wireless network, an indication message indicating configuration information for a configuration of at least one element associated with the wireless communication node or UE, where a type of the configuration comprises one of: an activation of the at least one element, a deactivation of the at least one element, or a configuration update related to the at least one element; and where the at least one element comprises at least one of: a cell, a frequency layer, a frequency band, a carrier, a Transmission and Reception Point (TRP), a beam, a Transmission Configuration Indication (TCI) state, an antenna, an antenna port, a MIMO layer, a rank, an antenna panel, a reference signal, or a reference resource.

In some embodiments, a method performed by a UE in a wireless network is disclosed. The method may include receiving, from a wireless communication node in the wireless network, an indication message indicating configuration information for a configuration related to at least one element associated with the wireless communication node or UE, where a type of the configuration comprises one of: an activation of the at least one element, a deactivation of the at least one element, or a configuration update related to the at least one element; and where the at least one element comprises at least one of: a cell, a frequency layer, a frequency band, a carrier, a Transmission and Reception Point (TRP), a beam, a Transmission Configuration Indication (TCI) state, an antenna, an antenna port, a MIMO layer, a rank, an antenna panel, a reference signal, or a reference resource.

In some embodiments, there is a wireless UE and/or a wireless communication node comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example wireless network node.

FIG. 3 shows an example user equipment.

FIG. 4a shows example time domain characteristic for activating, deactivating, or updating an element in the wireless communication network.

FIG. 4b shows another example time domain characteristic for activating, deactivating, or updating an element in the wireless communication network.

FIG. 5 shows example steps for activating, deactivating, or updating an element based on various messages in the wireless communication network.

FIG. 6a shows an example associated operation triggered directly by an indication message.

FIG. 6b shows an example associated operation triggered indirectly by an indication message.

### DETAILED DESCRIPTION

### Wireless Communication Network

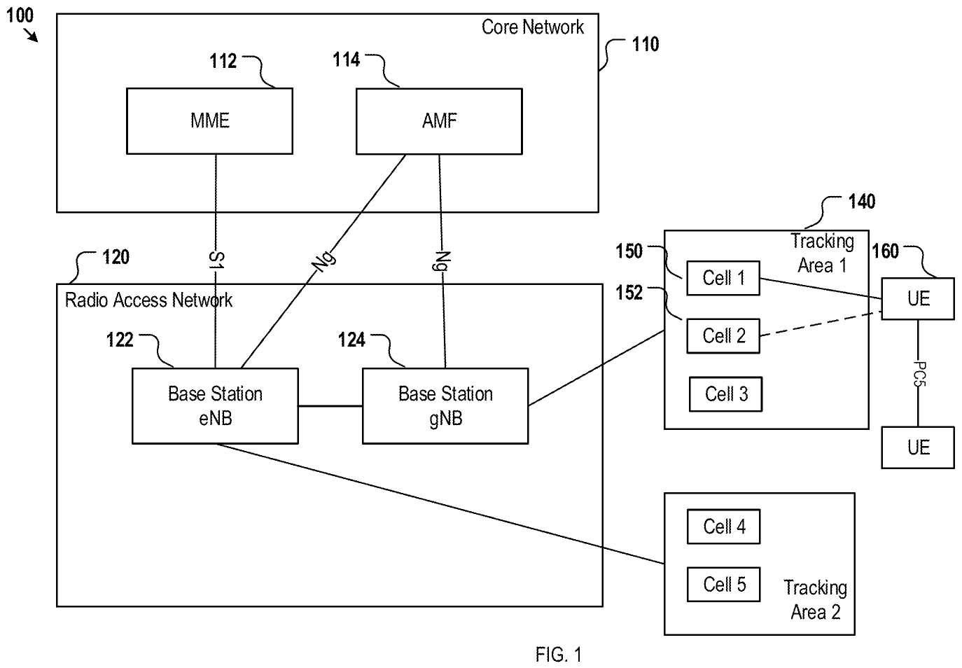

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, or a Next generation NodeB (gNB) for 5G New Radio (NR), or any other type of signal transmitting/receiving device such as a UMTS NodeB. The eNB 122 communicates with the MME 112 via an S1 interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

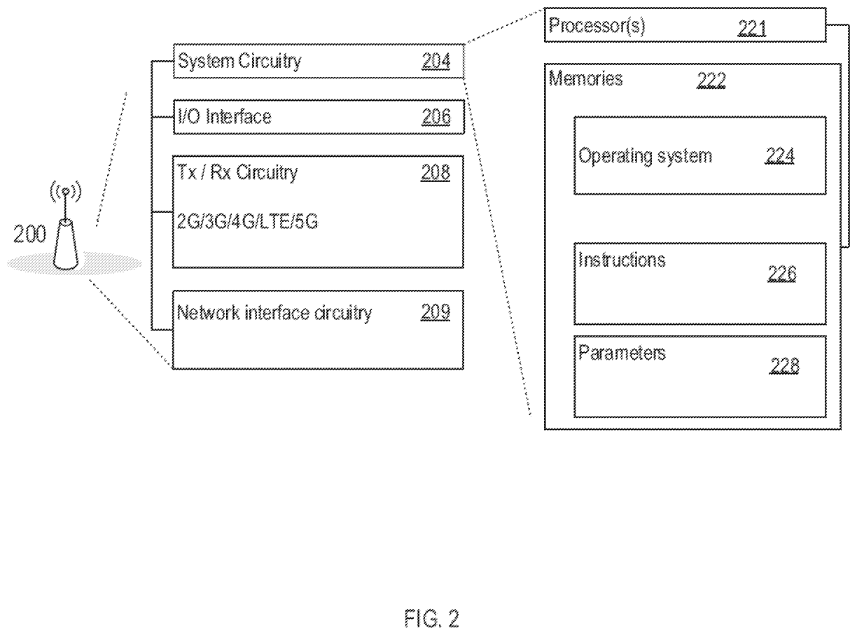

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

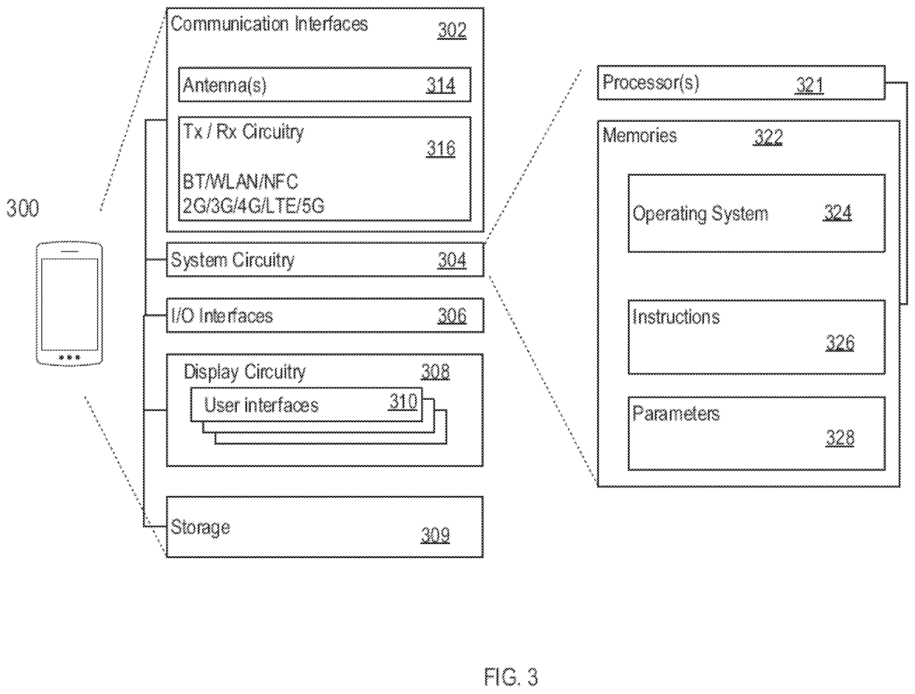

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAG, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

### Power Saving Factors

Improving the network and UE energy efficiency is a critical consideration when designing and deploying a green and sustainable wireless communication system.

In some embodiments, cell activation and deactivation is supported for network power saving. However, if the cell is deactivated, the base station would not transmit any signal or channel, which may impact UE access. To save network power consumption and reduce performance impact on UEs, a more dynamic and fine granularity network activation and deactivated is considered. For example, switch off transmission or reception antenna/panel, instead of the whole cell.

Meanwhile, base station may indicate to the UEs in the cell of the activation/deactivated operation to assist UE adaptation. For example, if the base station informs UE that an antenna is switched off, UE can correspondingly turn off some radio frequency hardware to save power, for example, due to reduced base station antenna configuration and complexity.

The wireless communication network includes many elements which interact with each other. In this disclosure, various embodiments for controlling power consumption at various element level are disclosed. Elements of the wireless communication network are described in this disclosure. Signaling interaction between the base station and the UE is disclosed. The base station, based on real time network condition, may target elements in different granularity and at different level, and indicate to the UE that the targeted element needs to be deactivated (power off), activated, or updated with new configuration. Therefore, a fine control of power consumption is achieved.

### Element to Apply Power Saving

In this disclosure, various embodiments are disclosed for deactivating, activating, or update the configuration targeting different level of elements, or elements serving different network functionalities. The term “element” is used to represent an object or an entity that is subject to power control or power saving using the methods disclosed in this disclosure. Power saving may be implemented by, for example, deactivating an element, activating an element, or update the configuration of an element. In some implementation, the configuration impacts the power consumption of the element.

An element may be a hardware including a hardware circuitry, a hardware component, a hardware module, or any combination thereof. An element may also be a functionality such as signal measurement and report. An element may also be a software which supports the functionality or controls the hardware. An element may also be other virtual entities, such as signal, or time/frequency resources. There is no limitation imposed to the type of elements in this disclosure. Elements may be in different level and may be categorized in different granularity. For example, an element may be a whole base station, or an antenna in the base station, or an antenna port of the antenna.

Exemplary elements may include: cell, frequency layer, frequency band, carrier, Transmission and Reception Point (TRP), beam, Transmission Configuration Indication (TCI) state, antenna, antenna port, antenna panel, antenna element, Multiple-Input Multiple-Output (MIMO) layer, rank, reference signal, reference resource, and spatial relation information. In some embodiments, the rank includes a rank of channel matrix, or channel rank. In some embodiments, the MIMO layer may be also termed as transmission layer, or layer in this disclosure.

By applying deactivation, activation, or update of the configuration on elements in different level, a fine granularity of power control or power saving may be achieved. Meanwhile, the impact on system performance may be reduced with the fine granularity operation. For example, an antenna panel contains multiple antenna elements. Depending on network condition, various number of antenna elements, or the whole antenna panel may be deactivated to meet a real time performance requirement yet saving power consumption to the maximum extent. For another example, a certain frequency band maybe deactivated, and power saving may be achieved as procedures related to signal transmission and reception in the particular band are skipped.

The elements may interact with each other, therefore, update on one element may impact another element. For example, the configuration of reference signal or reference signal resource (may also be referred to as reference resource) includes information relevant to antenna, antenna port, TCI state, etc. In some embodiments, the activation/deactivation/update of the antenna, the antenna port, or the TCI state may have an impact on reference signal or reference resource. On the other hand, in some embodiments, the activation/deactivation/update of reference signal or reference resource may be used to determine or derive the configuration of antenna, antenna port, TCI state, etc.

### Time Domain Characteristics of Power Configuration

In some embodiments, the configuration (i.e., activation, deactivation, or update) may be periodic and last for a certain duration. For example, an antenna element may be powered off every 10 seconds, and the powered off condition may be applied for or may last for a duration of 5 seconds.

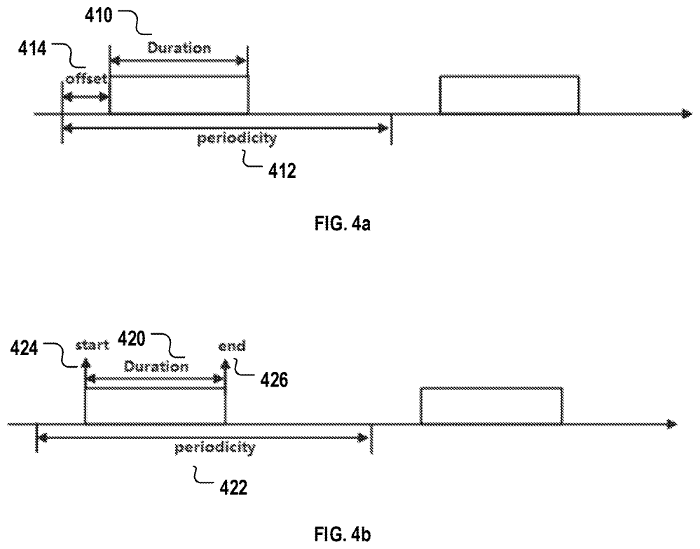

FIG. 4a illustrates an example time domain characteristics of a configuration with duration 410, and a periodicity 412. The duration 410 starts with an offset 414 relative to the start of each period. In some embodiments, the offset may be zero, or may be determined by higher layer signaling.

FIG. 4b illustrates another example time domain characteristics of a configuration with duration 420, and a periodicity 422. The duration 420 starts from a start time position 424 to and ends at an end time position 426. In some embodiments, the start time position and/or the end time position may be defined in relative to a reference point. In some embodiments, the reference point may be determined by at least one of a higher layer signaling, a UE capability, or a time slot when UE receives the indication of the configuration.

In some embodiments, the activation/deactivation/update operation may be a-periodic, for example, the operation may be just one shot. The duration of the activation deactivation, or update may be determined by at least one of a duration length, a start time position, or an end time position. In some embodiments, the start time position may be determined by at least one of a higher layer signaling, a UE capability, or a sub-carrier spacing. In some embodiments, the end time position may be determined by at least one of a higher layer signaling, a UE capability, or a sub-carrier spacing.

In some embodiments, the duration may be determined by at least one of:
a timer;
a higher layer parameter;
a sub-carrier spacing;
a carrier frequency;
a Medium Access Control-Control Element (MAC CE); or
a Downlink Control Information (DCI).

### Configuration Pre-Condition

The base station may be triggered to initiate a certain configuration (i.e., activation/deactivation/update) under at least one of the following conditions:
The number of UEs in the cell is above or below a threshold;
The number of UEs in the base station is above or below a threshold;
Coverage of a cell;
A traffic pattern or service being currently transmitted; or
UE assistance information.

For example, when the number of UEs in a cell is below a threshold, the base station may determine to deactivate the cell and instruct the UEs to move to another cell. The threshold may be predetermined and may be adjusted based on network requirement.

For another example, UE assistance information may include at least one of traffic pattern, UE speed information, UE position information, a preferred number of carriers, or a preferred number of resource blocks that is reported by UE to network (e.g., base station). For example, the traffic pattern includes at least one of data packet size, or data rate. In some embodiments, the UE speed information indicates or includes UE mobility speed. In some embodiments, the UE speed information includes at least one of high-mobility speed, medium-mobility speed, low-mobility speed, or stationary state, where the speed ranges for the high, medium, and low speed may be predetermined and may be configured or updated

In some embodiments, when a cell covers the areas of other cells (e.g., multiple cells cover the same area), the base station may deactivate one or more cells and instruct the UEs to move to another cell. In some embodiments, when multiple cells cover the same area, the base station may deactivate one or more cells with few UEs.

In some embodiments, for the service with small data packet and/or insensitive to delay, the base station may initiate a certain configuration, for example, reduce the antenna, bandwidth, or MIMO layer.

### Indication of Configuration

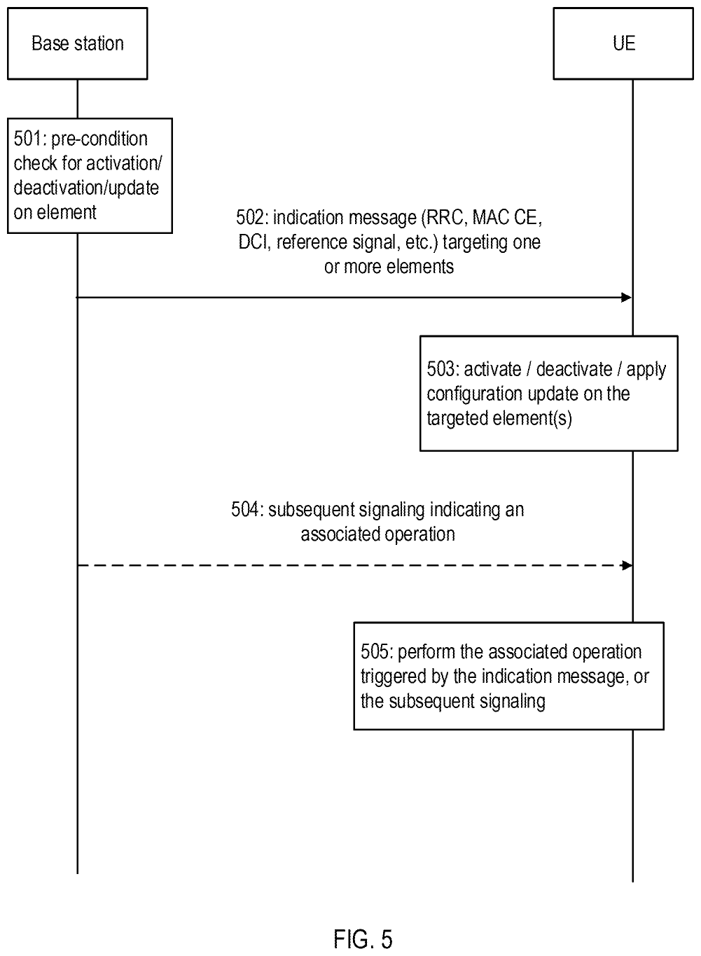

Referring to FIG. 5, once the base station determines a configuration needs to be applied at 501, the base station may indicate to the UE about the configuration, for example, via an indication message 502. In some embodiments, the step 501 may be skipped, i.e., the base station may directly indicate to the UE about the configuration. After the UE receives the indication message, at 503, the UE applies the configuration, whether it is an activation, deactivation, or an update on the target element(s).

### Indication Signaling

The indication message may be transmitted via at least one of:
a higher layer signaling;
a Downlink Control Information (DCI); or
a reference signal.

The higher layer signaling may include a Radio Resource Control (RRC) message, a Medium Access Control-Control Element (MAC CE) message, or a DCI message. In some embodiments, the higher layer parameter may include system information block (SIB).

### Information in the Indication Message/Configuration Information

The indication message (or signaling) may indicate the type of the configuration, i.e., whether the configuration is an activation operation, a deactivation operation, or an update operation.

The indication message may also indicate the identification information for the element to which the configuration applies.

The indication message may also indicate a pattern, or time domain characteristics of the configuration. The pattern may be determined by at least one of a periodicity, an offset, a duration, a start time position, an end time position. The duration indicates how long the particular configuration lasts. For example, the deactivation lasts for 2 seconds, or a configuration update lasts for 10 seconds.

The indication message may further indicate a sleep mode from a list of sleep modes or sleep configurations. Each sleep mode in the list corresponds to a duration. The list of sleep modes may be predetermined, or may be signaled to the UE. The indication message may indicate an index to the list, so the UE may determine which sleep mode to apply. Refer to Table 1 below for an example sleep mode configuration.

TABLE 1
Sleep Modes

| Sleep mode | Duration of deactivation state |
|---|---|
| Sleep mode 1 | Duration 1 |
| Sleep mode 2 | Duration 2 |
| . . . | . . . |
| Sleep mode N | Duration N |

In some embodiments, the content of the indication message may be split into multiples messages. For example, one message is used to indicate the ID of the element, and another message is used to indicate the configuration.

In some embodiments, the indication message may include a handover indication to the UE. For example, if the base station decides to switch off a carrier element, it may hand over the UE to another base station, and the indication message may carry this handover indication.

### DCI Format

As described above, the indication message for the configuration information may be a DCI.

In some embodiments, the DCI format includes at least one of: DCI format 0-1, DCI format 0-2, DCI format 1-1, or DCI format 1-2.

In some embodiments, the configuration indication may be jointly encoded with, or indicated by at least one of the following DCI information field:
a Sounding Reference Signal (SRS) resource indicator field;
an SRS request field;
a precoding information field;
a number of transmission layers field;
an antenna port field;
a Channel State Information (CSI) request field;
a Physical Uplink Control Channel (PUCCH) resource indicator field;
a transmission configuration indication field;
a Secondary Cell (SCell) dormancy indication field; or
a Single TRP/Multi-TRP dynamic switching field.

In some embodiments, the joint encoding may be implemented by at least one of the following schemes:

### Scheme 1

Use a codepoint or value to indicate information of the aforementioned information fields, and the configuration information associated with element activation/deactivation/update at the same time.

Referring to Table 2 below for an example. The codepoint is carried in one of the aforementioned DCI fields. In this example, the codepoint takes 3 bits and may represent 8 different interpretations. Under each interpretation, there is indication information for identifying the elements, in this example, the antenna port(s). Each codepoint also indicates a detailed configuration information for applying the activation/deactivation/update configuration. The indication may be achieved by using an index or a pointer to a list of different interpretations. The list of interpretations may be predetermined, or may be determined via signaling.

TABLE 2
Joint Encoding

| Codepoint | interpretation |
|---|---|
| 000 | antenna port indication #0, |
| | activation/deactivation/update information #0 |
| 001 | antenna port indication #1, |
| | activation/deactivation/update information #1 |
| . . . | . . . |
| 111 | antenna port indication #7, |
| | activation/deactivation/update information #7 |

### Scheme 2

Use a first block in an information field to indicate the information that is already assigned to the information field, and adding a second block in the information field to indicate the indication information associated with element activation/deactivation/update. The information field includes at least one of: SRS resource indicator field, precoding information field, number of transmission layers field, antenna port field, SRS request field, CSI request field, PUCCH resource indicator field, transmission configuration indication field, SCell dormancy indication field, Single TRP/Multi-TRP switching field.

Table 3 below illustrates an example using the antenna ports indication field in the DCI. The first block carried the original information which is serving antenna ports indication, and a newly added second block is used for indicating configuration information.

TABLE 3
Two Blocks in an Information Field

| | |
|---|---|
| First block | Second block |
| (antenna ports indication) | activation/deactivation/ |
| | update information |

In some embodiments, rather than using a field to explicitly indicate the configuration information, like the two schemes described above, the configuration information may be implicitly indicated. For example, the configuration information may be indicated by one of the following information fields: SRS resource indicator field, precoding information field, number of transmission layers field, antenna port field, SRS request field, CSI request field, PUCCH resource indicator field, transmission configuration indication field, SCell dormancy indication field, Single TRP/Multi-TRP switching field.

In some embodiments, the information of one element may be derived by the configuration information of another element.

For example, at least one of the number of antenna ports, the number of transmission layers, or the number of antennas may be determined by or derived from the SRS resource indicator DCI field. For another example, the number of antenna ports, or the number of transmission layers may be determined by or derived from the maximum number of ports of SRS resource, or the maximum number of transmission layers among one or more SRS resources indicated by SRS resource indicator DCI field.

For another example, at least one of the number of antenna ports, the number of transmission layers, or the number of antennas may be determined by or derived from the antenna port indication DCI field. For yet another example, the maximum number of antenna ports, or the number of transmission layers may be indicated by the antenna port indication DCI field first, then the number of antenna ports, or the number of transmission layers may be determined by or derived from the maximum number of antenna ports, or the number of layers.

For another example, at least one of the number of antenna ports, the number of transmission layers, or the number of antennas may be determined by the precoding information together with the number of layers which is indicated by a DCI field.

For yet another example, TRP activation/de-activation may be determined by the single TRP/multi-TRP switching indication DCI field.

In some embodiments, the indication (explicit indication and/or the implicit indication) for the configuration information as described above may be enabled when at least one of the information fields is set to a predetermined codepoint:
Frequency/time domain resource DCI field;
hybrid automatic repeat request (HARM) process number DCI field;
HARQ-acknowledgement field;
Short message indicator DCI field;
MCS indication DCI field; or
Redundancy version DCI field.

The predetermined codepoint may be all zeros, all ones, or another predetermined pattern.

In some embodiments, the indication of configuration information may be carried by a dedicated DCI information field.

When a UE is in the RRC idle or inactive state, the UE needs to detect Physical Downlink Control Channel (PDCCH) with Cyclic Redundancy Check (CRC) bits scrambled by Paging Radio Network Temporary Identifier (P-RNTI) for paging message, or PDCCH with CRC scrambled by System Information RNTI (SI-RNTI) for system information. In some embodiments, the CRC bits of the DCI carrying the indication of the configuration information may be scrambled by a P-RNTI or a SI-RNTI. In some embodiments, the indication of configuration information may be carried by the short message in the DCI. In some embodiments, the indication of configuration information may be carried by the reserved bits in the DCI.

In some embodiments, the DCI includes a paging-early indication. The paging-early indication comprises an indication to the UE whether to monitor paging occasion or not.

In some embodiments, the DCI as the indication message may be a group-common DCI, which carries configuration information for one or more UEs. The DCI format includes at least one of DCI format 2-0, DCI format 2-1, DCI format 2-2, DCI format 2-3, DCI format 2-4, DCI format 2-5, or DCI format 2-6.

The DCI may include one or more information blocks. In some embodiments, as shown in Table 4, each block corresponds to a UE and a serving cell associated with the UE. In some embodiments, each block corresponds to a serving cell.

TABLE 4
Multiple Information Blocks for Configuration Information

| | | | | |
|---|---|---|---|---|
| Block #a | Block #b | . . . | Block #c | Block #d |
| Serving cell #1 | Serving cell #2 | | Serving cell #1 | Serving cell #2 |
| UE #a | UE #a | | UE #b | UE #b |

In some embodiments, a UE is configured with at least one of the following: a position information for the information blocks, or a DCI size. With this information, the UE may decode the configuration information from the DCI.

In some embodiments, the size of the group-common DCI is aligned with at least one of the following DCI formats:
DCI format 1-0 monitored in common search space; or
DCI format 1-0 monitored in UE specific search space.

In some embodiments, the size alignment is implemented by zero-padding or truncation. For example, if the size of the group-common DCI is less than the size of DCI format 1-0 in common search space set, a number of zeros is appended to the group-common DCI until the payload size equals to that of a format 1_0 DCI monitored in common search space. In another example, if the size of the group-common DCI is larger than the size of DCI format 1-0 in common search space set, the information field of group-common DCI is truncated until the payload size equals to DCI size of format 1_0 monitored in common search space.

In some embodiments, the DCI in format 1_0 in common search space and the group common DCI are monitored in the same serving cell. In some embodiments, the DCI in format 1_0 in UE specific search space and the group common DCI are monitored in the same serving cell.

### Detailed Indication Message Content

The detailed content of the configuration information for activation/deactivation/update is described herein.

### A Maximum Value

In some embodiments, a maximum number (or value) is carried in the configuration information. The maximum number applies to, or is associated with at least one of: a cell, a frequency layer, a frequency band, a carrier, a TRP, a beam, a transmission configuration indication (TCI) state, an antenna, an antenna port, a MIMO layer, a rank, an antenna panel, a reference signal, or a reference resource. In some embodiments, the maximum number applying to, or associated with a cell is a maximum number of cells. In some implementations, the cell is used for downlink transmission and/or uplink transmission.

In some embodiments, the maximum number applying to, or associated with a frequency layer includes a maximum number of frequency layers.

In some embodiments, the maximum number applying to, or associated with a frequency band includes a maximum number of frequency bands. In some embodiments, the maximum number applying to, or associated with a frequency band is a maximum number of resource blocks of a frequency band.

In some embodiments, the maximum number applying to, or associated with a carrier includes a maximum number of carriers. In some implementation, the carrier is used for downlink transmission and/or uplink transmission.

In some embodiments, the maximum number applying to, or associated with a TRP includes a maximum number of TRPs. In some implementation, the TRP is used for transmission and/or reception.

In some embodiments, the maximum number applying to, or associated with a TCI includes a maximum number of TCI states. In some embodiments, the maximum number applying to, or associated with a TCI includes a maximum ID of TCI state.

In some embodiments, the maximum number applying to, or associated with an antenna includes a maximum number of antennas.

In some embodiments, the maximum number applying to, or associated with an antenna port includes a maximum number of antenna ports.

In some embodiments, the maximum number applying to, or associated with a transmission layer includes a maximum number of transmission layers.

In some embodiments, the maximum number applying to, or associated with a rank includes a maximum number of ranks.

In some embodiments, the maximum number applying to, or associated with an antenna panel includes a maximum number of antenna panels.

In some embodiments, the maximum number applying to, or associated with a reference signal includes a maximum number of reference signals. In some embodiments, the maximum number applying to, or associated with a reference signal includes a maximum number of ports of the reference signal. In some embodiments, the maximum number applying to, or associated with a reference signal includes a maximum ID of the reference signal.

In some embodiments, the maximum number applying to, or associated with a reference resource includes a maximum number of reference resources. In some embodiments, the maximum number applying to, or associated with a reference resource includes a maximum number of ports of the reference resource. In some embodiments, the maximum number applying to, or associated with a reference resource includes a maximum ID of the reference resource.

In some embodiments, the maximum value may be indicated together with a type of element it applies to, so the UE knows what type of element that the maximum value applies to.

In some embodiments, an element with ID information larger than or equal to the maximum value is deactivated.

In some embodiments, an element with corresponding value larger than or equal to the maximum value is deactivated. For example, if the current number of ports of a reference resource is larger than the indicated maximum value of ports, then the reference resource is deactivated.

In some embodiments, if a corresponding value of an element is larger than the maximum value, the corresponding value of the element is updated as the indicated maximum value. For example, if the current configured maximum number of transmission layers is larger than the indicated maximum value of transmission layer, then maximum number of transmission layers configured is updated as the indicated maximum value. For another example, if the current configured number of ports of a reference resource is larger than the indicated maximum value of ports, then the number of ports of the reference resource configured is updated as the indicated maximum value of ports.

### A List of Configuration Information

In some embodiments, the configuration information for activation/deactivation/update of the element may be presented in a list. The list applies to, or is associated with at least one of: a cell, a frequency layer, a frequency band, a carrier, a TRP, a beam, a TCI state, an antenna, an antenna port, a MIMO layer, a rank, an antenna panel, a reference signal, or a reference resource.

In some embodiments, the list may be carried in a bitmap.

In some embodiments, the list may be indicated by a codepoint, and the list may include ID information for one or more elements to be activated/deactivated/updated.

In some embodiments, one or more elements may be grouped, and each group is associated with a group ID. The indication message is used to indicate a target group ID which points to a target group that contains the elements to be configured (for example, to be activated/deactivated/updated). Some examples are given below.

### Example 1

Step 1-1: A list of groups is configured by RRC signaling.
Step 1-2: A subset of groups from the list of groups is indicated by MAC CE.
Step 1-3: A target group from the subset of groups is indicated by DCI.

### Example 2

Step 2-1: A list of groups is configured by RRC signaling.
Step 2-2: A target group within the list of groups is indicated by DCI.

### Example 3

Step 3-1: A list of groups is configured by RRC signaling.
Step 3-2: A target group within the list of groups is indicated by MAC CE.

In some embodiments, a triggering state is associated with one or more elements. The indication message is used to indicate a triggering state, so the one or more elements may be derived from the indicated triggering state, and the configuration may be applied to the one or more elements.

### Example 1

Step 1-1: A list of triggering states associated with one or more elements is configured by RRC signaling.
Step 1-2: A subset of triggering states from the list of triggering states is indicated by MAC CE.
Step 1-3: A target triggering state from the subset of triggering states is indicated by DCI.

### Example 2

Step 2-1: A list of triggering states associated with one or more elements is configured by RRC signaling.
Step 2-2: A target triggering state from the list of triggering states is indicated by DCI.

### Example 3

Step 3-1: A list of triggering states associated with one or more elements is configured by RRC signaling.
Step 3-2: A target triggering state from the list of triggering states is indicated by MAC CE.

### A Threshold Value

In some embodiments, a threshold value may be indicated by the indication message. The threshold value applies to, or is associated with at least one of: a cell, a frequency layer, a frequency band, a carrier, a TRP, a beam, a TCI state, an antenna, an antenna port, a MIMO layer, a rank, an antenna panel, a reference signal, or a reference resource.

In some embodiments, the element with ID information larger than the threshold value is deactivated.

In some embodiments, the element with ID information smaller than the threshold value is deactivated.

In some embodiments, the element with ID information equal to the threshold value is deactivated.

In some embodiments, the element with ID information larger than the threshold value is updated according to another element. In some embodiments, the another element is the element with ID equal to the threshold value. In some embodiments, the another element is the element with the smallest index within the same type of elements. In some embodiments, the another element is the element with the largest index within the same type of elements. In some embodiments, the same type of elements are the same type of elements configured in the same bandwidth part, or cell, or cell group.

### A Source Element

In some embodiments, the configuration information includes a source element used as a reference to update the information of a target element. For example, a whole configuration or a partial configuration of the source element may be copied to the target element.

In some embodiments, the source element is indicated by the indication message.

In some embodiments, the source element is determined by a criterion associated with at least an ID, a threshold value, or a target element. For example, the source element may be the element with ID equal to or larger than a threshold value. For example, the source element may be the element with ID larger than the target element. For example, the source element may be the element with the smallest ID within the same type of elements. In some embodiments, the same type of elements is the same type of elements configured in the same bandwidth part, or cell, or cell group.

In some embodiments, the indication message includes the information of the source element and/or target element.

In some embodiments, the indication message includes a serving cell ID and/or a Bandwidth Part (BWP) ID.

In some embodiments, the indication message may include an RRC message, a MAC CE message, or a DCI message.

### Example 1

The configuration information includes a target element and a source element. The information of the target element may be updated as the source element. For example, Table 5 below illustrates that the source element is TCI state-i, and the target element is TCI state-j, wherein i, j are non-negative values. As indicated by this indication message, the TCI state-j is updated as TCI state-i.

TABLE 5
Source Element and Target Element

| | |
|---|---|
| source element | target element |
| (TCI state-i) | (TCI state-j) |

### Example 2

The configuration information includes a source element and more than one target element. The information of the all target elements are updated as the source element. For example, the target elements are TCI state-a, TCI state-b, and the source element is TCI state-c, where a, b, and c are non-negative values. With this update indication, the TCI state-a and TCI state-b in the target elements are updated as TCI state-c.

TABLE 6
Source Element and Target Elements

| | | |
|---|---|---|
| source element | target element 0 | target element 1 |
| (TCI state-c) | (TCI state-a) | (TCI state-b) |

### Example 3

In some embodiments, the configuration information includes N pairs of target element and source element.

| | | | | |
|---|---|---|---|---|
| target | source | . . . | target | source |
| element-1 | element-1 | | element-N | element-N |

### Higher Layer Signaling

In some embodiments, the indication message carrying the configuration information may be a higher layer signaling includes at least one of an RRC signaling, a MAC CE signaling, or a system information signaling.

### Reference Signal

In some embodiments, the indication message carrying the configuration information may be a reference signal, such as a reference signal with paging-early indication. The paging-early indication is used to indicate to the UE whether to monitor paging occasion or not.

### Indication to Other Base Station

In some embodiments, when the base station sends an indication message to the UE indicating configuration information, it is beneficial to also inform the configuration information to another base station, for example, a neighbor base station, so as to support better collaboration between the base stations and the UE. The base station may inform at least one of the following information to the another base station:
Type of element configuration: activation/deactivation/update;
ID information of the concerning element;
Pattern of element activation/deactivation/update operation: determined by at least one of a periodicity, an offset, or a duration. The duration defines how long the activation, the deactivation, or the update lasts;
A sleep mode, as described earlier;
Handover indication. In some embodiment, when a base station deactivates some element, for example, a cell, the base station may hand over the UEs in the cell to other base station.

### Element Configuration—Impact on Channel and Signal

In some embodiments, the elements interact with each other. For example, a number of ports of reference signal may be determined by an indication of number of antenna ports. In another example, a number of antenna ports may be derived by the configuration of the number of ports of reference signal. Therefore, the configuration of one element may impact other elements. In some other implementations, the indication of number of antenna ports may be used to determine the number of antenna port of a reference signal, or vice versa. Therefore, the indication (e.g., message or signaling carrying the indication) may be reduced by using one message to carry information for two or more elements.

The detailed schemes are disclosed below.

### Impact of TCI State Activation/Deactivation

In some embodiments, in the wireless communication network, the Downlink (DL) and/or Uplink (UL) beam management may be implemented by Transmission Configuration Indication (TCI) state framework. Under this framework, each TCI state is configured with one or more reference signals which are associated with a Quasi Co-Location (QCL) type. A TCI state implies which beam is used for DL reception or UL transmission. In some implementation, a TCI state is configured with a reference signal.

When a TCI state is activated/deactivated/update, a reference signal resource or reference signal resource set associated with the TCI state needs to be activated/deactivated/update correspondingly.

In some embodiments, the transmission occasion of a reference signal is determined by the corresponding reference signal resource. For example, the de-activation of reference signal implies the de-activation of the corresponding reference signal resource, or vice versa. For another example, the activation of reference signal implies the activation of the corresponding reference signal resource, or vice versa. For another example, the update of reference signal implies the update of the corresponding reference signal resource, or vice versa.

In some embodiments, the reference signal associated with the TCI state may be configured with at least one of:
The activated/deactivated/update TCI state; or
a TCI state which has the same reference signal as the one configured by the activated/deactivated/update TCI state;

In some embodiments, the reference signal associated with the TCI state is the same reference signal as the one configured by the activated/deactivated TCI state.

For example, if a particular TCI state is de-activated, it may imply reference signal configured by this TCI state and/or the corresponding transmission/reception beam associated with the configured reference signal needs to be de-activated. In this case, another reference signal configured with the same TCI state, or a different TCI state but associated with same reference signal also needs to be de-activated. The similar operation is also applied to activation or update configuration.

In some embodiments, two reference signals are the same if at they share at least one of: a reference signal type, a reference signal index, a serving cell ID, or a BWP ID.

In some embodiments, the reference signal set associated with the TCI state includes at least one reference signal resource which is configured with at least one of:
the activated/deactivated TCI state; or
a TCI state has the same reference signal as the one configured by the activated/deactivated TCI state.

In some embodiments, the reference signal set associated with the TCI state is the reference signal set comprising the same reference signal as the one configured by the activated/deactivated TCI state.

In some embodiments, for a UE, a certain channel or signal (e.g., a Physical Downlink Shared Channel (PDSCH)) may be configured with multiple TCI states by RRC signaling, and then a sub-set of the multiple TCI states may be activated by a MAC CE, and finally a desired TCI state may be indicated by a DCI. If a TCI state is deactivated, the UE is not expected to transmit UL channel/signal using the deactivated TCI state. If a TCI state is deactivated, the UE is not expected to receive DL channel/signal using the deactivated TCI state.

### Impact of Spatial Relation Information Activation/Deactivation

In some embodiments, the UL beam management procedure is implemented by spatial relation information framework. For example, each spatial relation information is configured with one or more reference signals which are associated with a QCL type. With the indication of spatial relation information, it implies which beam is used for UL transmission. In some implementations, the spatial relation information is configured with a reference signal.

When a spatial relation information is activated/deactivated, a reference signal or reference signal set associated with the spatial relation information needs to be activated/deactivated correspondingly.

In some embodiments, the associated reference signal is configured with at least one of:
the activated/deactivated/update spatial relation information; or
another spatial relation information set having the same reference signal as the activated/deactivated/update spatial relation information.

In some embodiments, the reference signal associated with the spatial relation information is a same reference signal as the one configured by the activated/deactivated/update spatial relation information. In some embodiments, if a spatial relation is de-activated, it may imply the reference signal configured by the spatial relation and/or the transmission/reception beam associated with the configured reference signal needs to be de-activated. In this case, another reference signal configured with the same spatial relation, or different spatial relation but associated with same reference signal also needs to be de-activated. The similar operation is also applied to activation or update configuration.

In some embodiments, when a spatial relation information is deactivated, the UE is not expected to be indicated to transmit UL channel/signal using the deactivated spatial relation information.

### Impact of Antenna Activation/Deactivation

When the maximum number of antenna is indicated as n (n is a non-negative integer) by the indication message, at least one of the following factors are constrained: number of Demodulation Reference Signal (DM-RS) ports, number of Channel State Information Reference Signal (CSI-RS) ports, number of transmission layers, number of ranks, number of Sounding Reference Signal (SRS) ports, precoding information, number of TCI states, number of reference resources, and number of reference resource sets. In some embodiments, these factors are constrained as m, where m a non-negative integer not larger than n. For example, m=n.

In some embodiments, when the number of TCI states is constrained as m via the indication message, the TCI state with ID equal to or larger than m needs to be deactivated.

In some embodiments, when the number of reference resources is constrained as m via the indication message, the reference resource with ID equal to or larger than m needs to be deactivated. In some embodiments, when the number of reference resources is constrained as m via the indication message, the reference resource with ports equal to or larger than m needs to be deactivated.

In some embodiments, when the number of reference resource sets is constrained as m via the indication message, the reference resource set with ID equal to or larger than m needs to deactivated. In some embodiments, when the number of reference resource sets is constrained as m via the indication message, the reference resource set with ports equal to or larger than m needs to deactivated.

In some embodiments, a number of zeros are padded in the Most Significant Bits (MSBs) or Least Significant Bits (LSBs) of the antenna port information field in a DCI with a first DCI format when a first condition is met. The first DCI format includes at least one of: DCI format 1-1, DCI format 1-2, DCI format 0-1, or DCI format 0-2. The first condition may be associated with a number of antenna ports determined by the indication message, and the first condition may include: the number of DM-RS ports determined by a higher layer parameter is larger than the number of DM-RS ports determined by the indication message.

In some embodiments, a number of zeros are padded in the MSB or LSB of the precoding information and transmission layer information field in a DCI with a second DCI format when a second condition is met. The second DCI format includes at least one of: DCI format 0-1, or DCI format 0-2. The second condition may be associated with at least one of the following parameters determined by the indication message: a number of antennas, a number of layers, or a rank.

The second condition includes at least one of the following:
The number of antennas determined by a higher layer parameter is larger than the number of antennas determined by the indication message;
The number of layers determined by a higher layer parameter is larger than the number of layers determined by the indication message; or
The number of ranks determined by a higher layer parameter is larger than the number of rank determined by the indication message.

### Impact of Maximum Number of Transmission Layers and Maximum Number of Antenna Ports

When the maximum number of transmission layers is indicated as n (n is a non-negative integer) by the indication message, or when the maximum number of antenna ports is indicated as n, at least one of the following factors are constrained: number of DM-RS ports, number of CSI-RS ports, number of transmission layers, number of rank, number of SRS ports, precoding information, number of TCI states, number of reference resources, and number of reference resource sets. In some embodiments, these factors are constrained as m, where m a non-negative integer not larger than n. For example, m=n.

In some embodiments, when the number of TCI states is constrained as m, the TCI state with ID equal to or larger than m needs to be deactivated.

### Impact on CSI Acquisition/Beam Management

In some embodiments, as various elements may interact with each other, or the operation of one element may depend on or propagate to another element, the indication message targeting an element may not only directly trigger configuration change on the targeted element, but may also trigger configuration change, or an operation on another related element indirectly. The operation triggered on the another related element may be referred to as an “associated operation” hereinafter.

For example, the CSI measurement and CSI reporting are associated with antenna configuration. If the antenna configuration is updated via the indication message, the configuration for CSI measurement and CSI reporting should also be updated accordingly, to make sure that the CSI measurement is accurate for the updated channel condition. In some embodiments, after an antenna is activated, deactivated, or updated as indicated by the indication message, a CSI acquisition procedure may be triggered by the same indication message, or by another signaling after the indication message, which will be described in more details below.

In some embodiments, after an antenna is updated, the configuration of CSI-RS is updated accordingly.

In some embodiments, the beam management is also associated with antenna configuration. If the antenna configuration is updated via the indication message, the configuration for beam management needs to be updated accordingly.

In some embodiments, at least one of the following operations is associated with the indication message: CSI measurement, CSI reporting, CSI request, SRS transmission, SRS request, radio link measurement, radio resource management (RRM) measurement, RRM reporting, radio link reporting, beam measurement, or beam reporting.

In some embodiments, the CSI measurement is associated with at least one of CSI-RS or Synchronization Signal Block (SSB).

In some embodiments, the radio link measurement is associated with at least one of CSI-RS or SSB.

In some embodiments, the beam measurement is associated with at least one of CSI-RS or SSB. In some embodiments, the beam reporting includes reporting of Layer 1 Reference Signal Received Power (L1-RSRP) and Layer 1 Signal to Noise and Interference Ratio (L1-SINR).

### Associated Operation Triggered by Indication Message

Referring to FIG. 5, in some embodiments, an associated operation is triggered or indicated by the indication message at step 505.

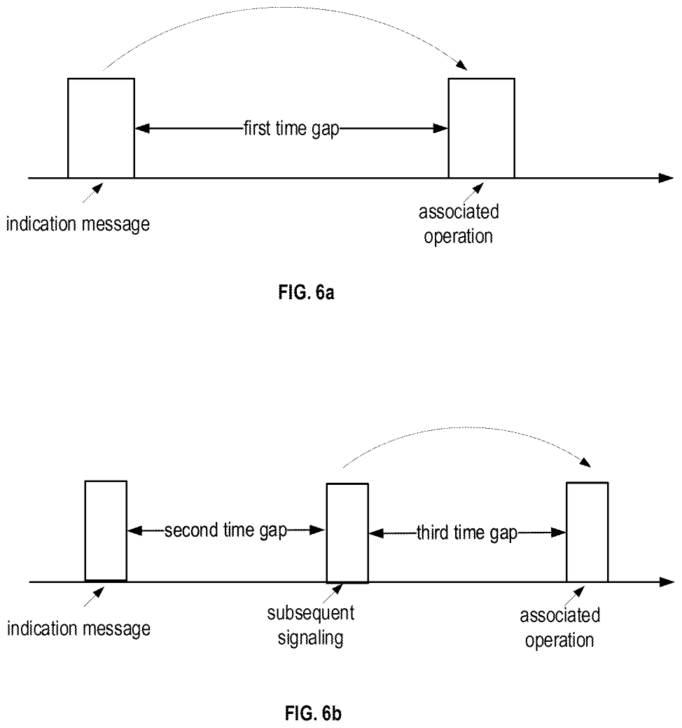

Further referring to FIG. 6a, the associated operation is performed after or no earlier than a first time gap after the indication message. The first time gap may be determined by at least one of the following: a UE capability, a factor associated with PDCCH processing time, a factor associated with PDSCH processing time, or a factor associated with PUSCH processing time, a frequency range, a sub-carrier spacing, a pre-determined value, or a higher layer parameter.

In some embodiments, the first time gap is defined by a first start time point and first end time point.

The first start time point is determined by at least one of the following:
a system frame, a slot, or a symbol in which the indication message is transmitted or received;
a system frame, a slot, or a symbol in which the Hybrid Automatic Repeat Request-Acknowledgement (HARQ-ACK) information of the indication message is transmitted or received; or
a pre-determined value.

The first end time point is determined by at least one of the following:
a system frame, a slot, or a symbol in which a CSI-RS is transmitted;
a system frame, a slot, or a symbol in which a Synchronization Signal Block (SSB) is received;
a system frame, a slot, or a symbol in which a CSI measurement, radio link measurement or a beam measurement is performed;
a system frame, a slot, or a symbol in which a CSI reporting, radio link reporting, RRM reporting, or a beam reporting is transmitted;
a system frame, a slot, or a symbol in which an SRS is transmitted or received; or
a pre-determined value.

### Associated Operation Triggered by Subsequent Signaling

Referring to FIG. 5, in some embodiments, after the UE receives the indication message, in step 504, it may further receive a subsequent signaling which triggers or indicates the associated operation to be performed at step 505.

Further referring to FIG. 6b, the subsequent signaling is received with a second time gap from the indication message, and the associated operation is performed after or no earlier than a third time gap from the subsequent signaling. In some embodiments, the subsequent signaling is received no earlier than a second time gap from the indication message, and the associated operation is performed after or no earlier than a third time gap from the subsequent signaling.

The second or the third time gap is determined by at least one of the following: a UE capability, a frequency range, a PDCCH processing time, a Physical Downlink Shared Channel (PDSCH) processing time, a time in response to a semi-persistent PDSCH release, a Physical Uplink Shared Channel (PUSCH) processing time, a sub-carrier spacing, a pre-determined value, or a higher layer parameter.

In some embodiments, the second time gap is defined by a second start time point and/or a second end time point.

The second start time point is determined by at least one of the following:
a system frame, a slot, or a symbol in which the indication message is transmitted or received;
a system frame, a slot, or a symbol in which the HARQ-ACK information of the indication message is transmitted or received; or
a pre-determined value.

The second end time point is determined by at least one of the following:
a system frame, a slot, or a symbol in which the subsequent signaling is transmitted or received;
a system frame, a slot, or a symbol in which the HARQ-ACK information of the subsequent signaling is transmitted or received; or
a pre-determined value.

In some embodiments, the third time gap is defined by a third start time point and/or a third end time point.

The third start time point is determined by at least one of the following:
a system frame, a slot, or a symbol in which the subsequent signaling is transmitted or received;
a system frame, a slot, or a symbol in which the HARQ-ACK information of the subsequent signaling is transmitted or received; or
a pre-determined value.

The third end time point is determined by at least one of the following:
a system frame, a slot, or a symbol in which a CSI-RS is transmitted;
a system frame, a slot, or a symbol in which an SSB is received;
a system frame, a slot, or a symbol in which a CSI measurement, radio link measurement, RRM measurement or a beam measurement is performed;
a system frame, a slot, or a symbol in which a CSI reporting, radio link reporting, RRM measurement or a beam reporting is transmitted; or
a system frame, a slot, or a symbol in which an SRS is transmitted or received; or
a pre-determined value.

### Applicable Use Case

In some embodiments, certain reference signals or channels are cell specific, or configured to more than one UE, or can be used by UE in RRC idle/inactive state. The deactivation/update operation is not applicable to these reference signals or channels.

The applicable use case of deactivation/update operation may be restricted according to channel type. The channel type includes at least control channel, or data channel. The channel type includes at least physical broadcast channel, or data channel. The channel type includes at least downlink channel, or uplink channel.

The applicable use case of deactivation/update operation may also be restricted according to reference signal type.
In some embodiments, the reference signaling type includes SSB, CSI-RS, SRS, and positioning reference signal.
In some embodiments, the reference signal type is determined by the time domain characteristics of the reference signal. For example, periodic reference signal, semi-persistent reference signal, aperiodic reference signal.
In some embodiments, the reference signaling type is determined by the usage of reference signal. For example, the usage includes at least one of Radio Resource Management (RRM) measurement, radio link measurement, or beam failure detection.

The applicable use case of deactivation/update operation may also be restricted according to CSI type.
In some embodiments, the CSI type includes at least one of: periodic CSI measurement and/or reporting, semi-persistent CSI measurement and/or reporting, or aperiodic CSI measurement and/or reporting.
In some embodiments, the CSI type is determined by the content of CSI reporting. In some implementations, the content of CSI reporting includes type I CSI reporting, or type II CSI reporting. In some implementations, the content of CSI reporting includes wideband CSI reporting, or sub-band CSI reporting. In some implementations, the content of CSI reporting includes L1-RSRP and/or L1-SINR. In some implementations, the content of CSI reporting may include CSI reporting other than L1-RSRP and/or L1-SINR.
In some embodiments, the CSI type is determined by the priority of CSI reporting.

The applicable use case of deactivation/update operation may also be restricted according to at least one of the following:
Search space set;
DCI format;
UE capability;
UE assistance information;
Higher layer signaling.

In some embodiments, deactivation/update operation is not applicable to PDCCH with CRC scrambled a pre-determined RNTI. In some embodiments, deactivation/update operation is not applicable to PDCCH with CRC scrambled by at least one of the following RNTIs: Paging RNTI (P-RNTI), System Information RNTI (SI-RNTI), Random Access RNTI (RA-RNTI), Msg-B RNTI, or Temporary Cell RNTI (TC-RNTI).

In some embodiments, deactivation/update operation is not applicable to Physical Downlink Shared Channel (PDSCH) or Physical Uplink Shared Channel (PUSCH) scheduled by PDCCH with CRC scrambled. In some embodiments, deactivation/update operation is not applicable to PDSCH or PUSCH scheduled by PDCCH with CRC scrambled by at least one of the following RNTIs: P-RNTI, SI-RNTI, RA-RNTI, Msg-B RNTI, or TC-RNTI.

In some embodiments, deactivation/update operation is not applicable to PDCCH monitored in at least one of the following search space set type: search space set type 0, search space set type 0A, search space set type 1, or search space set type 2.

In some embodiments, deactivation/update operation is not applicable to SSB.

In some embodiments, deactivation/update operation is not applicable to at least one of periodic reference signal or semi-persistent reference signal.

In some embodiments, deactivation/update operation is not applicable to at least one of: SSB, CSI-RS, SRS, or positioning reference signal.

### Application Delay

In some embodiments, once the UE receives an indication message, the deactivation/activation/update operation may be applied after a delay. The delay may be determined by at least one of the following: UE capability, a frequency range, a sub-carrier spacing, a pre-determined value, a higher layer parameter, a time slot when HARQ-ACK information is transmitted or received, a PDCCH processing time, a PDSCH processing time, a time in response to a semi-persistent PDSCH release, or a PUSCH processing time.

In some embodiments, the delay is defined by a fourth start time position and/or a fourth end time position.

The fourth start time point may be determined by at least one of the following:
a system frame, a slot, or a symbol in which the indication message is transmitted or received;
a system frame, a slot, or a symbol in which the HARQ-ACK information of the indication message is transmitted or received; or
a pre-determined value.

The fourth end time point may be determined by: a system frame, a slot, or a symbol in which the indication message is applied.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method performed by a wireless communication node in a wireless network, comprising:
transmitting, to a User Equipment (UE) in the wireless network, an indication message indicating configuration information for a configuration of at least one element associated with the wireless communication node or the UE, wherein:
the indication message is transmitted via at least one of: a higher layer signaling; a Downlink Control Information (DCI); or a reference signal, and the higher layer signaling is implemented in at least one of:
a Radio Resource Control (RRC) signaling;
a MAC CE signaling; or
a system information signaling;
a type of the configuration comprises one of: an activation of the at least one element, a deactivation of the at least one element, or a configuration update related to the at least one element; and
the at least one element comprises at least one of: a cell, a frequency layer, a frequency band, a carrier, a Transmission and Reception Point (TRP), a beam, a Transmission Configuration Indication (TCI) state, an antenna, an antenna port, a MIMO layer, a rank, an antenna panel, a reference signal, or a reference resource.

2. The method of claim 1, wherein the configuration is characterized by at least one of the following combinations:
a periodicity, a duration lasted for the configuration, and a time offset relative to a reference time point;
the periodicity, the duration, a start time position relative to the reference time point, and an end time position relative to the reference time point;
the periodicity, the duration, the start time position relative to the reference time point;
the duration, the start time position relative to the reference time point; or
the duration, the start time position relative to the reference time point, and the end time position relative to the reference time point.

3. The method of claim 2, wherein the duration is determined by at least one of:
a timer;
a higher layer parameter;
a sub-carrier spacing;
a carrier frequency;
a Medium Access Control-Control Element (MAC CE); or
a Downlink Control Information (DCI).

4. The method of claim 1, wherein transmitting the indication message comprises:
transmitting the indication message in response to a condition being met, wherein the condition comprises one or more criteria associated with at least one of a number of UEs in the cell, a number of UEs in the wireless communication node, or UE assistance information.

5. The method of claim 1, wherein the configuration information comprises a list of sleep modes, each sleep mode corresponding to a deactivation duration indicating a period for the deactivation of the at least one element.

6-7. (canceled)

8. The method of claim 1, wherein the indication message is transmitted via the DCI, a format of the DCI comprising at least one of:
a DCI format 0-1;
a DCI format 0-2;
a DCI format 1-1; or
a DCI format 1-2.

9. The method of claim 8, wherein the configuration information is jointly encoded with, or indicated by at least one of the following information fields of the DCI:
a Sounding Reference Signal (SRS) resource indicator field;
an SRS request field;
a precoding information field;
a number of transmission layers field;
an antenna port field;
a Channel State Information (CSI) request field;
a Physical Uplink Control Channel (PUCCH) resource indicator field;
a transmission configuration indication field;
a Secondary Cell (SCell) dormancy indication field; or
a Single TRP/Multi-TRP dynamic switching field.

10. (canceled)

11. The method of claim 9, wherein a joint encoding or indication of the configuration information with a DCI information field is enabled or is indicated by at least one of the following fields of the DCI being set to a predetermined value:
a frequency/time domain resource field;
a Hybrid Automatic Repeat Request (HARQ) process number field;
a HARQ Acknowledgement (HARQ-ACK) field;
a Modulation and Coding Scheme (MCS) indication field; or
a redundancy version field.

12. The method of claim 1, wherein Cyclic Redundancy Check (CRC) bits of the DCI is scrambled by one of a Paging Radio Network Temporary Identifier (P-RNTI) or a System Information RNTI (SI-RNTI).

13. The method of claim 1, wherein the DCI comprises a paging-early indication, the paging-early indication indicating to the UE whether to monitor paging occasion or not.

14. The method of claim 1, wherein:
the DCI comprises a group common DCI, the group common DCI comprising at least one block, each of the at least one block comprising configuration information corresponding to one UE and a serving cell associated with the one UE; and
a size of the group common DCI is aligned with one of the following DCI formats:
a DCI format 1-0 monitored in common search space; or
a DCI format 1-0 monitored in UE specific search space.

15. (canceled)

16. The method of claim 1, wherein configuration information comprises a maximum number of at least one of the following:
cells;
frequency layers;
frequency bands;
carriers;
TRPs;
beams;
a TCI states;
antennas;
antenna ports;
MIMO layers;
transmission layers;
ranks;
antenna panels;
reference signals; or
reference resources.

17-24. (canceled)

25. A method performed by a User Equipment (UE) in a wireless network, comprising:
receiving, from a wireless communication node in the wireless network, an indication message indicating configuration information for a configuration related to at least one element associated with the wireless communication node or the UE,
wherein a type of the configuration comprises one of: an activation of the at least one element, a deactivation of the at least one element, or a configuration update related to the at least one element; and
wherein the at least one element comprises at least one of: a cell, a frequency layer, a frequency band, a carrier, a Transmission and Reception Point (TRP), a beam, a Transmission Configuration Indication (TCI) state, an antenna, an antenna port, a MIMO layer, a rank, an antenna panel, a reference signal, or a reference resource.

26. The method of claim 25, further comprising:
in response to the configuration information indicating an activation of the TCI state, activating a reference signal associated with the TCI state; and
in response to the configuration information indicating a deactivation of the TCI state, deactivating the reference signal associated with the TCI state.

27. The method of claim 26, further comprising:
in response to the configuration information indicating a deactivation of the TCI state, stopping transmitting uplink channel or uplink signal using the TCI state, or stopping receiving downlink channel or downlink signal using the TCI state.

28. The method of claim 25, further comprising:
in response to the configuration information indicating an activation of a spatial relation information, activating a reference signal associated with the spatial relation information; and
in response to the configuration information indicating a deactivation of a spatial relation information, deactivating the reference signal associated the spatial relation information.

29. The method of claim 25, wherein the configuration information indicates that a maximum number of antennas is n, or that a maximum number of antenna port is n, or that a maximum number of Multiple-Input Multiple-Output (MIMO) layer is n, n being a positive integer, the method further comprising updating a number of at least one of the following to a non-negative integer less than or equal to n:
DM-RS ports;
CSI-RS ports;
transmission layers;
ranks;
SRS ports;
TCI states;
reference resources; or
reference resource sets.

30. The method of claim 29, further comprising:
in response to the updated number of DM-RS ports being less than a number of DM-RS ports indicated by a higher layer parameter, padding Most Significant Bits (MSBs) or Least Significant Bits (LSBs) with a number of zeros in an antenna port information field of a DCI, wherein the number of zeros is determined by the updated number of DM-RS ports.

31-46. (canceled)

47. A wireless communication node comprising a memory for storing computer instructions and a processor in communication with the memory, wherein, when the processor executes the computer instructions, the processor is configured to cause the device to:
transmit, to a User Equipment (UE), an indication message indicating configuration information for a configuration of at least one element associated with the wireless communication node or the UE, wherein:
the indication message is transmitted via at least one of: a higher layer signaling; a Downlink Control Information (DCI); or a reference signal, and the higher layer signaling is implemented in at least one of:
a Radio Resource Control (RRC) signaling;
a MAC CE signaling; or
a system information signaling;
a type of the configuration comprises one of: an activation of the at least one element, a deactivation of the at least one element, or a configuration update related to the at least one element; and
the at least one element comprises at least one of: a cell, a frequency layer, a frequency band, a carrier, a Transmission and Reception Point (TRP), a beam, a Transmission Configuration Indication (TCI) state, an antenna, an antenna port, a MIMO layer, a rank, an antenna panel, a reference signal, or a reference resource.

48. A device for wireless communication comprising a memory for storing computer instructions and a processor in communication with the memory, wherein, when the processor executes the computer instructions, the processor is configured to implement a method in claim 25.
